(19) United States
(12) Patent Application Publication
(10) Pub. No.: US 2025/0332639 A1
(43) Pub. Date: Oct. 30, 2025

(54) ULTRAFAST LASER SHOCK FORGING ASSISTED LASER POWDER BED FUSION (LPBF) METHOD CAPABLE OF INHIBITING FORMATION OF THERMAL CRACKS IN HIGH-STRENGTH ALUMINUM ALLOY

(71) Applicant: Air Force Engineering University, Xi'an (CN)

(72) Inventors: Liucheng Zhou, Xi'an (CN); Xinlei Pan, Xi'an (CN); Xiaoqing Liang, Xi'an (CN); Cenchao Xie, Xi'an (CN); Rongping Wang, Xi'an (CN)

(21) Appl. No.: 18/968,966

(22) Filed: Dec. 4, 2024

(30) Foreign Application Priority Data
Apr. 29, 2024 (CN) 2024105327988

(51) Int. Cl. B22F 10/31; B22F 3/24; B22F 10/28; B22F 10/366; B22F 10/66

(52) U.S. Cl. CPC B22F 10/31; B22F 10/28; B22F 10/366; B22F 10/66; B22F 2003/247; B22F 2201/11; B22F 2301/052

(57) ABSTRACT

Provided is an ultrafast laser shock forging assisted laser powder bed fusion (LPBF) method capable of inhibiting formation of thermal cracks in a high-strength aluminum alloy. Technical points of the present disclosure: During a LPBF process of an aluminum alloy, a molten layer is subjected to shock forging with a mechanical effect of ultra-high-pressure shock waves induced by an ultrafast laser to reduce a stress level of the molten layer, and a stress level is controlled layer by layer to eliminate the local stress concentration, thereby inhibiting the formation of thermal cracks. Advantages of the present disclosure: During a LPBF-based additive manufacturing process, a stress field is controlled to inhibit the formation of thermal cracks, and there is no need to add an alloying element or adopt a post-treatment, resulting in a simple and reliable process. A thermal crack density is accurately and efficiently controlled layer by layer.

### TECHNICAL FIELD

The present disclosure relates to the technical field of additive manufacturing, and specifically to an ultrafast laser shock forging assisted laser powder bed fusion (LPBF) method capable of inhibiting formation of thermal cracks in a high-strength aluminum alloy.

### BACKGROUND

Because a high-strength aluminum alloy has strong sensitivity to heat, during a laser powder bed fusion (LPBF)-based additive manufacturing process of the high-strength aluminum alloy, the processing characteristics such as a high temperature gradient and rapid cooling lead to the uneven deformation of grains, a high amplitude tensile residual stress is easy to introduced locally, and defects such as thermal cracks and pores are often generated at grain boundaries after solidification, which seriously affects the mechanical properties of a formed component. In addition, during an additive manufacturing process of a high-strength aluminum alloy, the inhibition of thermal cracks is one of the most important problems need to be solved.

However, there are some drawbacks in the existing in-situ alloying or thermal treatment methods. For example, in the method of adding an alloying element such as zirconium (Zr) to narrow a solidification temperature range, impurities will be introduced to affect the mechanical properties of an aluminum alloy itself. When a heat treatment process is adopted, it is difficult to control a temperature, and the secondary deformation is easy to occur.

### SUMMARY

In view of the deficiencies existing in the art, an objective of the present disclosure is to provide an ultrafast laser shock forging assisted LPBF method capable of inhibiting formation of thermal cracks in a high-strength aluminum alloy, so as to solve the problems in the above background.

The above objective of the present disclosure is allowed by the following technical solutions:

An ultrafast laser shock forging assisted LPBF method capable of inhibiting formation of thermal cracks in a high-strength aluminum alloy is provided, where the ultrafast laser shock forging assisted LPBF method involves a host and control panel, a central controller, an image recognition and monitoring system, a scanning galvanometer used for nanosecond laser, an scanning galvanometer used for ultrafast laser, and a workbench, and the ultrafast laser shock forging assisted LPBF method includes the following specific steps:
S1, setting parameters through the scanning galvanometer used for nanosecond laser and the scanning galvanometer used for ultrafast laser;
S2, adjusting a device for a pre-work, including: adjusting a position of a substrate, setting a scraper, and turning on an argon supply, such that working conditions in a chamber meet a preset working state;
S3, spreading a powder, melting the powder by the scanning galvanometer used for nanosecond laser, and after the powder melt is solidified rapidly, and allowing shock forging by the scanning galvanometer used for ultrafast laser; and
S4, after the shock forging is completed, turning off the argon supply, and after a state inside the chamber returns to normal, opening a chamber door and removing the substrate.

In a preferred embodiment, the present disclosure can be further configured as follows: in the S1, a nanosecond laser in the scanning galvanometer used for nanosecond laser is subjected to parameter optimization according to crack and pore defects of a printing specimen:
a scanning path of the nanosecond laser is directional light and rotates by 45° to 67° layer by layer; and
in the S1, a scanning path of an ultrafast laser in the scanning galvanometer used for ultrafast laser is in a “Z” shape.

In a preferred embodiment, the present disclosure can be further configured as follows: The working conditions in the S2 include: an atmosphere, a substrate temperature, and key parameters of a blower system and a laser.

In a preferred embodiment, the present disclosure can be further configured as follows: The spreading a powder in the S3 includes: evenly spreading the powder on a powder bed, where it is ensured that excess powders on the workbench are effectively recovered into an excess material tank.

In a preferred embodiment, the present disclosure can be further configured as follows: A time interval between nanosecond laser and the ultrafast laser is 0.5 s to 5 s, and the nanosecond laser and the ultrafast laser each enter a standby state after completing a work.

In a preferred embodiment, the present disclosure can be further configured as follows: For ultrafast laser shock forging assisted LPBF of a plurality of layers, after a first round of operations in the S3 is completed, a powder-spreading device is started once again and prepared for a second round of powder-spreading operations, and the nanosecond laser and the ultrafast laser conduct a second round of operations, wherein the S3 is conducted repeatedly to allow melting and forging for each layer under accurate actions of the lasers until scanning operations for all layers are completed.

In a preferred embodiment, the present disclosure can be further configured as follows: In the S4, after the substrate is removed, a sample on the substrate is wire-cut to accurately separate a target component, and the target component is polished and post-treated as necessary.

In summary, the present disclosure includes at least one of the following beneficial technical effects:

During a LPBF-based additive manufacturing process, a stress field is controlled to inhibit the formation of thermal cracks, and there is no need to add an alloying element or adopt a post-treatment, resulting in a simple and reliable process. A thermal crack density is accurately and efficiently controlled layer by layer, such that a formed aluminum alloy component has a high quality and excellent performance.

### BRIEF DESCRIPTION OF THE DRAWINGS

FIG. 1 is a schematic diagram of the ultrafast laser shock forging assisted LPBF in the present disclosure;

FIG. 2 is a schematic diagram of the device in the present disclosure;

FIG. 3 is a schematic flow chart of the present disclosure;

FIG. 4 is a comparison diagram of residual stresses of 7075 aluminum alloy samples manufactured by the ultrafast laser shock forging assisted LPBF in the present disclosure and LPBF; and

FIG. 5 is a microscopic comparison diagram of surfaces of 7075 aluminum alloy samples manufactured by the ultrafast laser shock forging assisted LPBF in the present disclosure and LPBF.

Reference numerals: 1: workbench; 2: scanning galvanometer used for nanosecond laser; 3: thermal crack; 4: scanning galvanometer used for ultrafast laser; 5: image recognition and monitoring system; 6: host and control panel; 7: central controller; 8: printing surface; 9: nanosecond laser; and 10: ultrafast laser.

### DETAILED DESCRIPTION OF THE EMBODIMENTS

The present disclosure is further described in detail below with reference to the accompanying drawings.

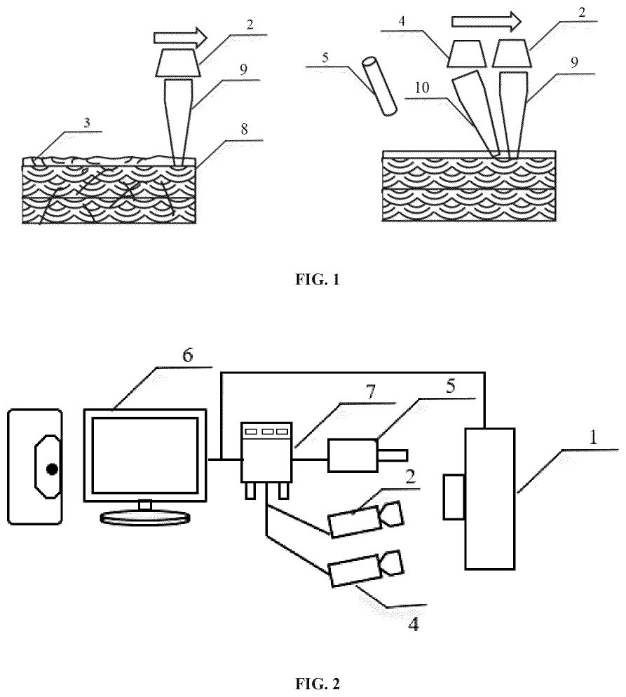

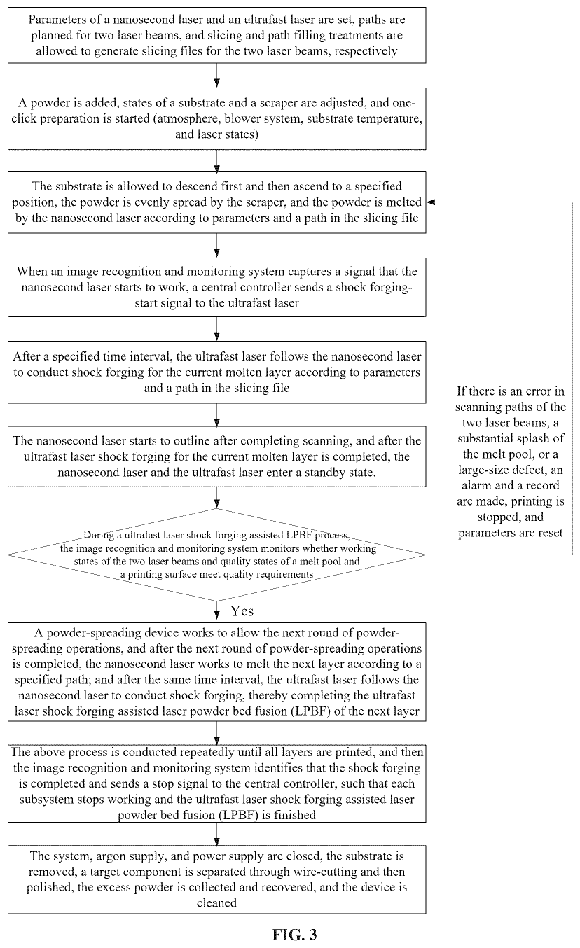

As shown in FIG. 1 to FIG. 3, the present disclosure discloses an ultrafast laser shock forging assisted LPBF method capable of inhibiting formation of thermal cracks in a high-strength aluminum alloy, where the ultrafast laser shock forging assisted LPBF method involves a host and control panel 6, a central controller 7, an image recognition and monitoring system 5, a scanning galvanometer 2 used for nanosecond laser, a scanning galvanometer 4 used for ultrafast laser, and a workbench 1. The workbench 1 includes a printing surface 8. All components involved in the method are commanded by the central controller 7, and the whole process is programmed by the host and control panel 6. And the scanning galvanometer 2 used for nanosecond laser is mainly configured to melt a powder. The scanning galvanometer 4 used for ultrafast laser is configured to forge the solidified layer during LPBF process.

With a 7075 aluminum alloy as an example:

The method includes the following specific steps:

S1, Parameters of the scanning galvanometer used for nanosecond laser 2 and the scanning galvanometer used for ultrafast laser 4 are set.

Parameters of the nanosecond laser 9 are set as follows: Because a melting point of the 7075 aluminum alloy is 475° C. to 635° C. and a temperature of a melt pool should be higher than the melting point of the aluminum alloy, the temperature of the melt pool is set to 700° C. and a power is set to 250 W to 350 W. Parameters are optimized based on defects such as cracks and pores of a printing specimen. Finally, parameters of the nanosecond laser for the 7075 aluminum alloy are determined as follows: a spot diameter: 82 μm; a power: 250 W to 300 W; a scanning speed: 500 mm/s to 1,400 mm/s; a molten layer thickness: 30 μm to 70 μm; a line spacing: 80 μm to 150 μm; and a substrate temperature: 150° C. to 200° C. A scanning path of the nanosecond laser is directional light and rotates by 45° to 67° layer by layer to avoid the heat accumulation at a same position.

Parameters of the ultrafast laser 10 are set as follows:

In this embodiment, a 7075 aluminum alloy sample manufactured by LPBF has a large tensile residual stress of 300 MPa to 370 MPa. Therefore, a high-energy ultrafast laser is required to activate higher pressure shock wave to exert a forging effect, where a power of 10 W to 50 W and laser energy of 200 μJ to 800 μJ are adopted. Finally, parameters of the ultrafast laser 10 are determined as follows: a wavelength: 1,030 nm; a pulse duration: 200 fs to 600 fs; a power: 20 W to 50 W; laser energy: 200 μJ to 800 μJ; a scanning speed: 500 mm/s to 1,500 mm/s; a repetition frequency: 50 kHz to 100 kHz; a spot diameter: 40 μm to 80 μm; a overlapping: 33% to 67%; and a scanning path: a “Z” shape. Here, it is necessary to ensure that the ultrafast laser 10 and the nanosecond laser 9 do not overlap in movements.

A slicing treatment is conducted according to the above parameters, and then paths for the two laser beams are planned with path filling software to generate scanning parameters and path-planning files for the nanosecond laser and the ultrafast laser 10, respectively.

S2, A device is adjusted for a pre-work, including: a position of a substrate is adjusted, a scraper is set, and an argon supply is turned on, such that working conditions in a chamber meet a preset working state.

Specifically: An oven-dried powder is poured into a powder tank. Then, a powder bed device is started, the position of the substrate is accurately adjusted, and a status of the scraper is calibrated, so as to ensure the smooth proceed of powder-spreading. After the debugging is completed, a chamber door is closed to allow the start of printing. A slicing file of the powder bed is imported, and the argon supply is turned on to maintain an inert atmosphere in a printing chamber. A self-test process before ultrafast laser shock forging assisted LPBF is implemented, and the atmosphere, the substrate temperature, and key parameters of a blower system and a laser in the printing chamber are allowed to reach the preset working state to ensure the smooth proceed of the entire printing process.

S3, A powder is spread and then melted by the nanosecond laser via scanning galvanometer2 to obtain a powder melt, and after the powder melt is solidified rapidly, and shock forging is conducted by the ultrafast laser via scanning galvanometer4.

Specifically: The substrate is allowed to descend slowly and then accurately ascend to a preset molten layer thickness. The scraper is started synchronously. The powder is evenly spread on the powder bed, and excess powders on each working plane are effectively recovered in an excess material tank to maintain the cleanliness of each working surface. After completing a task, the scraper returns to an initial position, at which point the scanning galvanometer used for nanosecond laser is activated and the nanosecond laser 9 begins to melt the powder according to a specified path and specified parameters. The powder melt is allowed to be solidified to get ready for the next stage. When a working state of the nanosecond laser 9 is captured in real time by the image recognition and monitoring system 5, the central controller 7 immediately sends a start signal for ultrafast laser shock forging to the scanning galvanometer used for ultrafast laser 10. When a time interval between the nanosecond laser and the ultrafast laser is accurately controlled within 0.5 s to 5 s, the ultrafast laser 10 follows the scanning path of the nanosecond laser 9 closely, and the control system accurately identifies and uses parameters of a slicing file of the ultrafast laser 10 to allow the shock forging for a molten layer on a powder bed, thereby ensuring the accuracy of a manufacturing process and a quality of a component.

The nanosecond laser 9 outlines after melting all regions of the current layer according to a specified path, and then after the ultrafast laser shock forging for the current molten layer is completed, the nanosecond laser and the ultrafast laser 10 enter a standby state.

For the ultrafast laser shock forging assisted LPBF of a plurality of layers, the above operations can be repeated: A powder-spreading device is started once again and prepared for the next round of powder-spreading operations. After the next round of powder-spreading operations are completed, the nanosecond laser 9 immediately starts to work and melts the next powder layer along a predetermined path. After the same time interval, the ultrafast laser 10 follows the path of the nanosecond laser 9 to conduct a shock forging operation, thereby ensuring a printing quality of the next layer. The above process is conducted repeatedly to allow the melting and forging for each layer under the accurate actions of the lasers until scanning operations for all layers are completed.

At this point, the image recognition and monitoring system 5 accurately captures a shock forging-end signal and sends a stop command to the central controller 7. After the central controller receives the stop command, each subsystem stops running successively, indicating the end of an ultrafast laser shock forging assisted LPBF process.

During an ultrafast laser shock forging assisted LPBF process, in addition to recognizing ultrafast laser shock forging assisted LPBF-start and -end signals, the image recognition and monitoring system 5 monitors working states of the two laser beams and quality states of a melt pool and a printing surface; and when there is an error in scanning paths of the two laser beams, a substantial splash of the melt pool, or a large-size defect, an alarm and a record are made and printing is immediately stopped, thereby ensuring a quality of the ultrafast laser shock forging assisted LPBF process. According to monitored conditions, parameters such as laser energy, a repetition frequency, a laser pulse duration, and a spot size and a scanning path of the ultrafast laser 10 are adjusted in time.

S4, After the shock forging is completed, the argon supply is turned off, and after a state inside the chamber returns to normal, a chamber door is opened and the substrate is removed.

Specifically: The argon supply is turned off, and an air pressure and an atmosphere in the printing chamber are allowed to return to normal states. Then, the chamber door is gradually opened, and the substrate on which the printing is completed is removed.

After the substrate is removed, a sample on the substrate is wire-cut to accurately separate a target component, and the target component is polished and post-treated as necessary to improve the surface quality and service performance of the target component. Then, the remaining powder on the substrate and material tank is collected to ensure a tidy working region. In addition, the remaining powder is sieved and recovered for subsequent recycling.

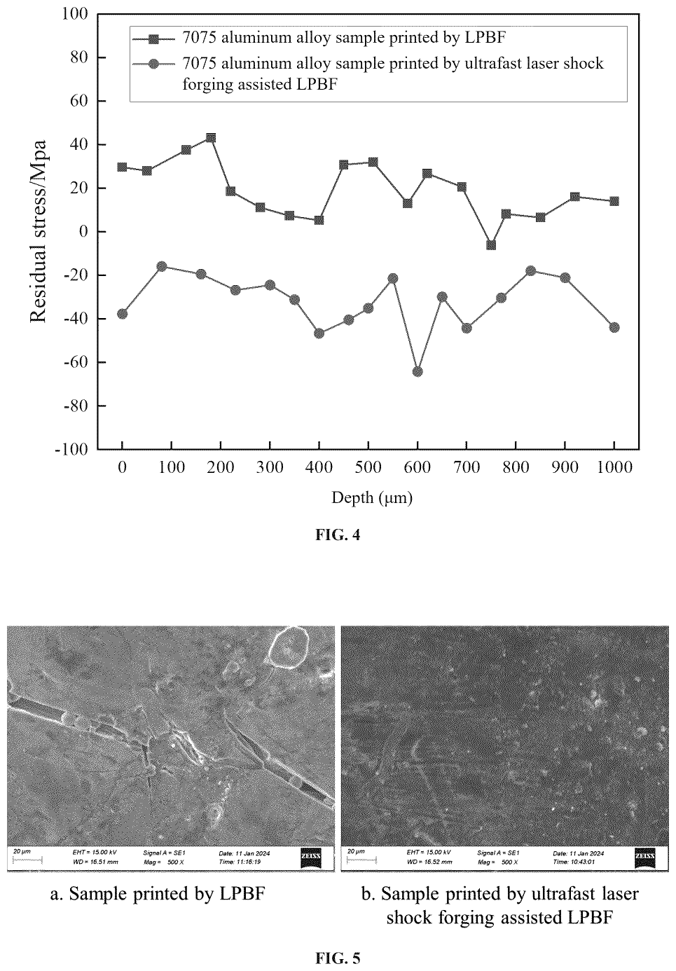

FIG. 4 is a comparison diagram of residual stress of 7075 aluminum alloy samples manufactured by the ultrafast laser shock forging assisted LPBF and LPBF. It can be seen from this figure that, compared with the 7075 aluminum alloy sample printed by the LPBF, residual stresses in surface and depth directions are converted from the original tensile residual stresses to compressive stresses in the 7075 aluminum alloy sample printed by the ultrafast laser shock forging assisted LPBF, with an amplitude of 20 MPa to 40 MPa, indicating that the method proposed in the present disclosure can effectively control a stress field distribution of an additive-manufactured component.

FIG. 5 is a microscopic comparison diagram of surfaces of 7075 aluminum alloy samples printed by the ultrafast laser shock forging assisted LPBF and LPBF, where the left panel shows a microscopic morphology of a surface of the 7075 aluminum alloy sample manufactured by the ultrafast laser shock forging assisted LPBF and the right panel shows a microscopic morphology of a surface of the 7075 aluminum alloy sample printed by the LPBF. It can be seen from this figure that the 7075 aluminum alloy sample printed with the shock forging of the ultrafast laser 10 has significantly-reduced thermal cracks 3 and an improved printing quality. The above results show that the ultrafast laser shock forging assisted LPBF method proposed in the present disclosure can effectively inhibit the generation of thermal cracks 3 in a 7075 aluminum alloy.

The above specific embodiments all are preferred embodiments of the present disclosure, but the protection scope of the present disclosure is not limited thereto. Therefore, all equivalent changes made in accordance with the structure, shape, and principle of the present disclosure shall fall within the protection scope of the present disclosure.

What is claimed is:

1. An ultrafast laser shock forging assisted laser powder bed fusion (LPBF) method capable of inhibiting formation of thermal cracks in a high-strength aluminum alloy, wherein the ultrafast laser shock forging assisted LPBF method involves a host and control panel (6), a central controller (7), an image recognition and monitoring system (5), a scanning galvanometer used for nanosecond laser (2), a scanning galvanometer used for ultrafast laser (4), and a workbench (1), and the ultrafast laser shock forging assisted LPBF method comprises the following specific steps:
S1, setting parameters through the scanning galvanometer used for nanosecond laser (2) and the scanning galvanometer used for ultrafast laser (4);
S2, adjusting a device for a pre-work, comprising: adjusting a position of a substrate, setting a scraper, and turning on an argon supply, such that working conditions in a chamber meet a preset working state;
S3, spreading a powder, melting the powder by the scanning galvanometer used for nanosecond laser (2) to obtain a powder melt, and after the powder melt is solidified rapidly, and allowing shock forging by the scanning galvanometer used for ultrafast laser (4); and
S4, after the shock forging is completed, turning off the argon supply, and after a state inside the chamber returns to normal, opening a chamber door and removing the substrate.

2. The ultrafast laser shock forging assisted LPBF method capable of inhibiting formation of thermal cracks (3) in a high-strength aluminum alloy according to claim 1, wherein in the S1, a nanosecond laser (9) in the scanning galvanometer used for nanosecond laser (2) is subjected to parameter optimization according to crack and pore defects of a printing specimen:
a scanning path of the nanosecond laser (9) is directional light and rotates by 45° to 67° layer by layer; and
in the S1, a scanning path of an ultrafast laser (10) in the scanning galvanometer used for ultrafast laser is in a “Z” shape.

3. The ultrafast laser shock forging assisted LPBF method capable of inhibiting formation of thermal cracks (3) in a high-strength aluminum alloy according to claim 1, wherein the working conditions in the S2 comprise: an atmosphere, a substrate temperature, and key parameters of a blower system and a laser.

4. The ultrafast laser shock forging assisted LPBF method capable of inhibiting formation of thermal cracks in a high-strength aluminum alloy according to claim 1, wherein the spreading a powder in the S3 comprises: evenly spreading the powder on a powder bed, wherein it is ensured that excess powders on the workbench (1) are effectively recovered into an excess material tank.

5. The ultrafast laser shock forging assisted LPBF method capable of inhibiting formation of thermal cracks in a high-strength aluminum alloy according to claim 1, wherein a time interval between the nanosecond laser (9) and the ultrafast laser (10) is 0.5 s to 5 s, and the nanosecond laser (9) and the ultrafast laser (10) each enter a standby state after completing a work.

6. The ultrafast laser shock forging assisted LPBF method capable of inhibiting formation of thermal cracks in a high-strength aluminum alloy according to claim 4, wherein for ultrafast laser shock forging assisted LPBF of a plurality of layers, after a first round of operations in the S3 is completed, a powder-spreading device is started once again and prepared for a second round of powder-spreading operations, and the nanosecond laser (9) and the ultrafast laser (10) conduct a second round of operations, wherein the S3 is conducted repeatedly to allow melting and forging for each layer under accurate actions of the lasers until scanning operations for all layers are completed.

7. The ultrafast laser shock forging assisted LPBF method capable of inhibiting formation of thermal cracks in a high-strength aluminum alloy according to claim 1, wherein in the S4, after the substrate is removed, a sample on the substrate is wire-cut to accurately separate a target component, and the target component is polished and post-treated as necessary.
